(19) United States
(12) Patent Application Publication
(10) Pub. No.: US 2025/0044097 A1
(43) Pub. Date: Feb. 6, 2025

(54) LIGHT REFRACTION OR DISPERSION AND LANDMARK BASED NAVIGATION

(71) Applicant: The Charles Stark Draper Laboratory, Inc., Cambridge, MA (US)

(72) Inventors: Juha-Pekka J. Laine, Boston, MA (US); Avinash Agrawal, Cambridge, MA (US); Lucas D. Benney, Arlington, MA (US); Gregory Blasche, Burlington, MA (US); Matthew T. Jamula, North Reading, MA (US); Charles Anthony McPherson, Cambridge, MA (US); Dorothy C. Poppe, Cambridge, MA (US); Stephen P. Smith, Acton, MA (US)

(73) Assignee: The Charles Stark Draper Laboratory, Inc., Cambridge, MA (US)

(21) Appl. No.: 18/790,444

(22) Filed: Jul. 31, 2024

Related U.S. Application Data
(60) Provisional application No. 63/530,444, filed on Aug. 2, 2023.

(51) Int. Cl. G01C 21/02; B64G 1/24; B64G 1/36; G01C 21/24; G06T 5/70; G06T 7/70

(52) U.S. Cl. CPC G01C 21/025; B64G 1/245; B64G 1/361; G01C 21/24; G06T 5/70; G06T 7/70; G06T 2207/10036; G06T 2207/20024

(57) ABSTRACT

Navigation with light refraction or dispersion and landmark data is provided. A system can include a data processing system. The data processing system can receive a first image of a surface of a planet from a first camera. The data processing system can generate a first position dataset based on the first image and data representing landmarks of the surface of the planet. The data processing system can receive, by a second camera oriented towards an atmosphere of the planet, a second image. The data processing can generate, via a celestial body catalog, a second position dataset based at least in part on an amount of refraction or dispersion of light of a celestial body in a second image. The data processing system can determine, based on a filter applied to the first position dataset and the second position dataset, a position and attitude of a vehicle.

### CROSS-REFERENCE TO RELATED APPLICATION

This application claims the benefit of priority under 35 U.S.C. § 119 to U.S. Provisional Patent Application No. 63/530,444, filed on Aug. 2, 2023, which is hereby incorporated by reference herein in its entirety for all purposes.

### BACKGROUND

An aerial vehicle can receive navigation updates from a base station on Earth. The vehicle can use the navigation updates in order to perform navigation functions.

### SUMMARY

Technical solutions described herein are directed to navigation with light refraction or dispersion and landmark data. The vehicle of this technical solution can include a landmark camera and a celestial body camera. The landmark camera can capture images of the surface of the planet under the vehicle. The celestial body camera can be pointed towards a horizon of the planet and can capture light that is dispersed or refracted by the atmosphere of the planet. The vehicle can determine a first set of coordinates of the vehicle based on a comparison of the images of the surface to landmark data. The vehicle can determine a second set of coordinates of the vehicle based on an amount that the light of the celestial body is dispersed or refracted. Furthermore, the vehicle can use images of celestial bodies, and match the images of celestial bodies to a celestial body catalog to determine an attitude of the vehicle. The vehicle can combine the first position dataset and the second position dataset by applying a navigation filter to the first position dataset and the second position dataset. The navigation filter can be a filter that combines the first set of coordinates with the second set of coordinates. For example, the navigation filter can correct for errors in the first position dataset with the second position dataset, or correct for errors in the second position dataset with the first position dataset. By combining the first position dataset with the second position dataset, the vehicle may not need to rely on the base station corrections, such as an Earth Orientation Parameter Prediction (EOPP) parameter to account for the wobble or changes (e.g., slowing down or speeding up) of the rotation of the earth or another planet under the vehicle or a Precise Ephemeris (PE) parameter to account for atmospheric drag of the vehicle.

At least one aspect of the present disclosure is directed to a system. The system can include a data processing system including one or more processors, coupled with memory, to receive a first image of a surface of a planet from a first camera of a vehicle. The data processing system can generate a first position dataset based on the first image and data representing landmarks of the surface of the planet. The data processing system can receive, by a second camera of the vehicle oriented towards an atmosphere of the planet, a second image that includes light of a celestial body refracted or dispersed by the atmosphere of the planet. The data processing system can generate, via a celestial body catalog, a second position dataset based at least in part on an amount of refraction or dispersion of the light of the celestial body in the second image. The data processing system can determine, based on a filter applied to the first position dataset and the second position dataset, a position and attitude of the vehicle.

The data processing system can match two or more celestial bodies of the second image or a third image of a third camera with celestial bodies of the celestial body catalog to determine the attitude of the vehicle. The data processing system can correct, based on the filter applied to the first position dataset, the second position dataset, and the attitude determined from the two or more celestial bodies, the position and the attitude of the vehicle.

The data processing system can determine, based on the filter applied to the first position dataset and the second position dataset, the position of the vehicle in an earth centered inertial coordinate system and an earth centered earth fixed coordinate system.

The data processing system can correct, based on the filter applied to the first position dataset and the second position dataset, for a wobble of the planet and for an atmospheric drag of the vehicle without receiving an update parameter from a base station.

The data processing system can receive a third image captured at a first point in time and a fourth image captured at a second point in time from the second camera or a third camera, the third image including a first star and a first planet, the fourth image including a second star and a second planet. The data processing system can determine a third position dataset based on the third image and the fourth image. The data processing system can determine, based on the filter applied to the first position dataset, the second position dataset, and the third position dataset, the position and the attitude of the vehicle.

The data processing system can receive a third image captured at a first point in time and a fourth image captured at a second point in time from the second camera or a third camera, the third image including a first star and a first planet, the fourth image including a second star and a second planet. The data processing system can determine a third position dataset based on the third image and the fourth image. The data processing system can apply a first filter to the first position dataset. The data processing system can apply a second filter to the second position dataset. The data processing system can apply a third filter to the third position dataset. The data processing system can apply the filter to the first position dataset filtered by the first filter, the second position dataset filtered by the second filter, and the third position dataset filtered by the third filter to determine the position and the attitude of the vehicle.

The data processing system can receive a third image captured at a first point in time and a fourth image captured at a second point in time from the second camera or a third camera, the third image including a first star and a first planet, the fourth image including a second star and a second planet. The data processing system can determine a third position dataset based on the third image and the fourth image. The data processing system can correct, based on a first filter applied to the second position dataset and the third position dataset, the second position dataset. The data processing system can apply the filter to the corrected first position dataset and the corrected second position dataset.

The data processing system can receive an altitude of the vehicle. The data processing system can select between a co-sighting technique or at least one of a stellar horizon atmospheric dispersion or stellar horizon atmospheric refraction technique based on the altitude. The data processing system can generate the second position dataset based on the stellar horizon atmospheric dispersion or the stellar horizon atmospheric refraction technique and apply the filter to the first position dataset and the second position dataset responsive to a selection of the stellar horizon atmospheric dispersion or the stellar horizon atmospheric refraction technique. The data processing system can generate a third position dataset based on the co-sighting technique and apply the filter to the first position dataset and the third position dataset responsive to a selection of the co-sighting technique.

The data processing system can identify a constellation of celestial bodies in the second image based on the celestial body catalog, the constellation of celestial bodies including the celestial body and a second celestial body. The data processing system can determine an error between the constellation of celestial bodies in the second image and data the celestial body catalog. The data processing system can determine the second position dataset based at least in part on the error. The data processing system can apply the filter to the first position dataset and the second position dataset determined based on the error to determine the position and the attitude of the vehicle.

The data processing system can compare a first spectrum of the light of the celestial body of the second image captured by the second camera at a first point in time to a plurality of spectrums of the light of the celestial body at a plurality of altitudes. The data processing system can determine a first cone associated with the position of the vehicle based on the comparison of the first spectrum of the light to the plurality of spectrums. The data processing system can compare a second spectrum of the light of the celestial body of the second image captured by the second camera at a second point in time to the plurality of spectrums of the light of the celestial body at the plurality of altitudes. The data processing system can determine a second cone associated with a second position of the vehicle based on the comparison of the second spectrum of the light to the plurality of spectrums. The data processing system can determine the first position dataset based on an intersection of the first cone and the second cone. The data processing system can determine, based on the filter applied to the first position dataset and the second position dataset determined based on the intersection of the first cone and the second cone, the position and the attitude of the vehicle.

The system can include the first camera, the first camera coupled with the vehicle and oriented towards the planet below the vehicle. The system can include the second camera, the second camera coupled with the vehicle and oriented towards a horizon of the planet.

At least one aspect of the present disclosure is a method. The method can include receiving, by processing circuitry, a first image of a surface of a planet from a first camera of a vehicle. The method can include generating, by the processing circuitry, a first position dataset based on the first image and data representing landmarks of the surface of the planet. The method can include receiving, by the processing circuitry from a second camera of the vehicle oriented towards an atmosphere of the planet, a second image that includes light of a celestial body refracted or dispersed by the atmosphere of the planet. The method can include generating, by the processing circuitry via a celestial body catalog, a second position dataset based at least in part on an amount of refraction or dispersion of the light of the celestial body in the second image. The method can include determining, by the processing circuitry based on a filter applied to the first position dataset and the second position dataset, a position and attitude of the vehicle.

The method can include matching, by the processing circuitry, two or more celestial bodies of the second image or a third image of a third camera with celestial bodies of the celestial body catalog to determine the attitude of the vehicle. The method can include correcting, by the processing circuitry, based on the filter applied to the first position dataset, the second position dataset, and the attitude determined from the two or more celestial bodies, the position and the attitude of the vehicle.

The method can include determining, by the processing circuitry, based on the filter applied to the first position dataset and the second position dataset, the position of the vehicle in an earth centered inertial coordinate system and an earth centered earth fixed coordinate system.

The method can include receiving, by the processing circuitry, a third image captured at a first point in time and a fourth image captured at a second point in time from the second camera or a third camera, the third image including a first star and a first planet, the fourth image including a second star and a second planet. The method can include determining, by the processing circuitry, a third position dataset based on the third image and the fourth image. The method can include determining, by the processing circuitry based on the filter applied to the first position dataset, the second position dataset, and the third position dataset, the position and the attitude of the vehicle.

The method can include receiving, by the processing circuitry, an altitude of the vehicle. The method can include selecting, by the processing circuitry, between a co-sighting technique or at least one of a stellar horizon atmospheric dispersion or stellar horizon atmospheric refraction technique based on the altitude. The method can include generating, by the processing circuitry, the second position dataset based on the stellar horizon atmospheric dispersion or the stellar horizon atmospheric refraction technique and apply the filter to the first position dataset and the second position dataset responsive to a selection of the stellar horizon atmospheric dispersion or the stellar horizon atmospheric refraction technique. The method can include generating, by the processing circuitry, a third position dataset based on the co-sighting technique and apply the filter to the first position dataset and the third position dataset responsive to a selection of the co-sighting technique.

The method can include identifying, by the processing circuitry, a constellation of celestial bodies in the second image based on the celestial body catalog, the constellation of celestial bodies including the celestial body and a second celestial body. The method can include determining, by the processing circuitry, an error between the constellation of celestial bodies in the second image and data the celestial body catalog. The method can include determining, by the processing circuitry, the second position dataset based at least in part on the error. The method can include applying, by the processing circuitry, the filter to the first position dataset and the second position dataset determined based on the error to determine the position and the attitude of the vehicle.

The method can include comparing, by the processing circuitry, a first spectrum of the light of the celestial body of the second image captured by the second camera at a first point in time to a plurality of spectrums of the light of the celestial body at a plurality of altitudes. The method can include determining, by the processing circuitry, a first cone associated with the position of the vehicle based on the comparison of the first spectrum of the light to the plurality of spectrums. The method can include comparing, by the processing circuitry, a second spectrum of the light of the celestial body of the second image captured by the second camera at a second point in time to the plurality of spectrums of the light of the celestial body at the plurality of altitudes. The method can include determining, by the processing circuitry, a second cone associated with a second position of the vehicle based on the comparison of the second spectrum of the light to the plurality of spectrums. The method can include determining, by the processing circuitry, the first position dataset based on an intersection of the first cone and the second cone. The method can include determining, by the processing circuitry based on the filter applied to the first position dataset and the second position dataset determined based on the intersection of the first cone and the second cone, the position and the attitude of the vehicle.

At least one aspect of the present disclosure is directed to one or more computer-readable media storing instructions thereon, that, when executed by one or more processors, cause the one or more processors to receive a first image of a surface of a planet from a first camera of a vehicle. The instructions can cause the one or more processors to generate a first position dataset based on the first image and data representing landmarks of the surface of the planet. The instructions can cause the one or more processors to receive, by a second camera of the vehicle oriented towards an atmosphere of the planet, a second image that includes light of a celestial body refracted or dispersed by the atmosphere of the planet. The instructions can cause the one or more processors to generate, via a celestial body catalog, a second position dataset based at least in part on an amount of refraction or dispersion of the light of the celestial body in the second image. The instructions can cause the one or more processors to determine, based on a filter applied to the first position dataset and the second position dataset, a position and attitude of the vehicle.

The instructions can cause the one or more processors to match two or more celestial bodies of the second image or a third image of a third camera with celestial bodies of the celestial body catalog to determine the attitude of the vehicle. The instructions can cause the one or more processors to correct, based on the filter applied to the first position dataset, the second position dataset, and the attitude determined from the two or more celestial bodies, the position and the attitude of the vehicle.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example system that determines a position and attitude of the vehicle based on landmark data and light refraction or dispersion.

FIG. 2 is an example system that selects between navigating based on light refraction, light dispersion, and co-sighting.

FIG. 3 is an example system that applies a filter to a first position dataset determined from landmark data, a filter to a second position dataset determined from refraction or dispersion, and a filter to a third position dataset determined from co-sighting.

FIG. 4 is an example system that combines position datasets determined with a co-sighting technique and a stellar horizon atmospheric dispersion (SHAD) or stellar horizon atmospheric refraction (SHAR) technique to generate a filtered dataset, and a second filter that combines the filtered dataset with a position dataset determined from landmark data.

FIG. 5 is an example of a vehicle above a planet including a landmark camera and a celestial body camera.

FIG. 6 is an example of a cone for an altitude of the vehicle that can be determined based on refraction or dispersion.

FIG. 7 is an example schematic diagram of measurements used to determine the position of a vehicle based on light refraction.

FIG. 8 is an example method of determining a position and attitude of the vehicle based on landmark data and light refraction or dispersion.

FIG. 9 is an example computing architecture of a data processing system that can implement the systems and methods discussed herein.

### DETAILED DESCRIPTION

Following below are more detailed descriptions of various concepts related to, and implementations of, methods, apparatuses, and systems of a landmark and light dispersion or refraction based navigation. The various concepts introduced above and discussed in greater detail below may be implemented in any of numerous ways.

A vehicle, such as an airplane, helicopter, drone, spaceship, or satellite, can navigate based on global positioning (GPS) signals received from GPS satellites. However, in some circumstances, the vehicle may not be able to communicate with GPS satellites or it may be desirable to be disconnected from GPS satellites. For example, if GPS satellites are unavailable, the vehicle is in a location where no GPS satellites are accessible, or there is an equipment malfunction, the vehicle may not be able to communicate and navigate based on the GPS satellites. GPS signals can include corrections from ground stations. These updates can be or include an EOPP parameter or a PE parameter. The EOPP parameter can account or correct for the wobble of the earth or another planet under the vehicle. Because the Earth can have random wobble (or wobble that is difficult to reliably and accurately predict) in its rotation, due to changes in the molten core of the Earth, tidal waves, etc., a vehicle may use the EOPP to compensate for the random changes in the Earth's rotation. The PE parameter can account for atmospheric drag of the vehicle. However, if these correction parameters are unavailable, the position or attitude determined by the vehicle can have error. In this regard, a vehicle may be dependent on the ground station corrections to accurately navigate.

To solve for these and other technical issues, this technical solution can perform navigation with light refraction or dispersion and landmark data. The vehicle of this technical solution can include a landmark camera and a celestial body camera. As the vehicle flies or orbits above or around a planet, the landmark camera can capture images of the surface of the planet under the vehicle. Furthermore, a celestial body camera pointed towards a horizon of the planet can capture light that is dispersed or refracted by the atmosphere of the planet. Light of celestial bodies that are occluded by the earth, or where the planet is between the vehicle and the celestial bodies, can be dispersed or refracted by the atmosphere of the planet and travel around the planet in the atmosphere of the planet to the celestial camera. The vehicle can determine a first set of coordinates of the vehicle based on a comparison of the images of the surface to landmark data. The vehicle can determine a second set of coordinates of the vehicle based on an amount that the light of the celestial body is dispersed or refracted. The first set of coordinates can provide position in an Earth Centered Earth Fixed (ECEF) coordinate system, while the second set of coordinates can provide position in an Earth Centered Inertial (ECI) coordinate system. Furthermore, the vehicle can use images of celestial bodies, and match the images of celestial bodies to a celestial body catalog to determine an attitude of the vehicle.

The vehicle can combine the first position dataset and the second position dataset by applying a navigation filter to the first position dataset and the second position dataset. The navigation filter can be a filter that combines the first set of coordinates with the second set of coordinates. For example, the navigation filter can correct for errors in the first position dataset with the second position dataset, or correct for errors in the second position dataset with the first position dataset. The navigation filter can be used by the vehicle to determine a position or attitude of the vehicle. By combining the first position dataset with the second position dataset, the vehicle may not need to rely on GPS signals to navigate, and further may not need to rely on the base station corrections, such as an EOPP parameter to account for the wobble or changes (e.g., slowing down or speeding up) of the rotation of the earth or another planet under the vehicle or a PE parameter to account for atmospheric drag of the vehicle.

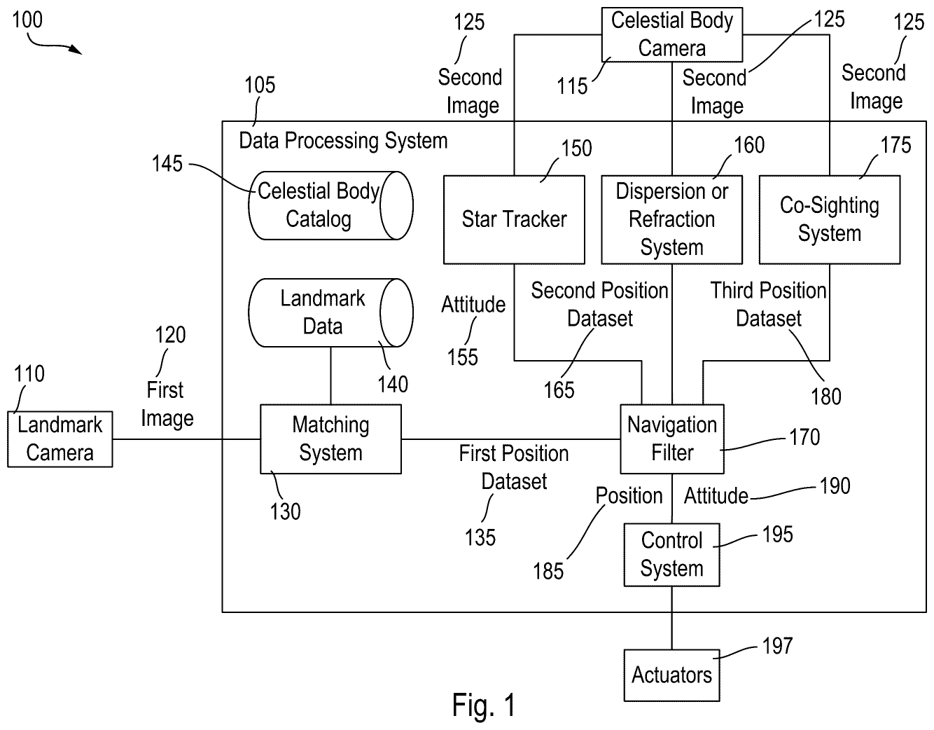

Referring now to FIG. 1, among others, an example system 100 that determines a position and attitude of the vehicle based on landmark data and light refraction or dispersion is shown. The system 100 can be a vehicle or a component of a vehicle. For example, the vehicle can be a satellite, e.g., a low earth orbit (LEO) satellite or near earth orbit (NEO), a medium Earth Orbit (MEO) satellite, a geostationary orbit (GEO) satellite, a geostationary transfer orbit (GTO) satellite. The vehicle can be a space ship, a space plane, a space telescope, a space station, etc. The vehicle can be a plane, drone, or missile. The vehicle can be manned or unmanned. The system 100 can be a system of a vehicle, such as an electrical system, a navigation system, or a computer system of the vehicle.

The system 100 can include a data processing system 105. The data processing system 105 can be or include a computer system, a processing system, processing circuitry, or other electronic processing equipment or apparatus. The system 100 can include cameras 110 and 115. The data processing system 105 can be electrically coupled or connected with the cameras 110 and 115 to receive images from the cameras 110 or 115. The system 100 can include at least one landmark camera 110. The landmark camera 110 can be positioned or oriented on a vehicle to capture a surface of a planet under the vehicle.

The data processing system 105 can receive the first image 120 of a surface of a planet from the landmark camera 110 of the vehicle. The landmark camera 110 can produce the first image 120. The first images 120 can include data representing landmarks of the surface of the planet, such as roads, mountains, forests, buildings, cities, rivers, airfields, road intersections, etc. The system 100 can include at least one celestial body camera 115. The landmark camera 110 can capture the first image 120 at a rate and provide the first images 120 to the data processing system 105 as the first images 120 are captured. The celestial body camera 115 can be positioned or oriented on the vehicle to capture a horizon of the planet or celestial bodies on a horizon of the planet. The celestial body camera 115 can capture at least one second image 125 that includes light of celestial bodies. The light can be refracted or dispersed by the atmosphere of the planet. The second image 125 can provide spectrum data of a celestial body or celestial bodies. The celestial body camera 115 can capture the second image 125 at a rate and provide the second images 125 to the data processing system 105 as the second images 125 are captured.

The data processing system 105 can include at least one matching system 130. The matching system 130 can generate a first position dataset 135. The matching system 130 can generate the first position dataset 135 based on the first image 120 and landmark data 140 representing landmarks of the surface of the planet. The matching system 130 can compare data of the first image 120 to landmark data 140. For example, the data processing system 105 can store a database, a data repository, a record, a set of data objects, a map, satellite images, or other data. The data processing system 105 can perform a matching algorithm or comparison algorithm to match the first image 120 with the landmark data 140. For example, the data processing system 105 can compare or match landmarks of the first image 120 with landmarks indicated by the landmark data 140. The matching system 130 can generate the first position dataset 135 responsive to identifying a match between the landmarks of the first image 120 with corresponding landmarks of the landmark data 140. The matching system 130 can determine a position, an altitude, or an attitude of the system 100 based on the match between the first image 120 and the landmark data 140. The position can be a two or three-dimensional coordinate. For example, the position can include x, y, and z coordinates. The position can be a position in an ECEF coordinate system or frame. The position can be a position in an ECEF World Geodetic System 1984 (WGS 84) coordinate system. The ECEF coordinate system can be a coordinate system defined with respect to a surface of the planet (e.g., with respect to the surface of the Earth).

The data processing system 105 can include at least one celestial body catalog 145. The celestial body catalog 145 can be an astronomical catalog that indicates the locations of planets, moons, stars, galaxies, asteroids, vehicles, nebulas, quasars, comets, or other celestial bodies. The celestial body catalog 145 can define trajectories, rotations, orbits, accelerations, positions, or movements of celestial bodies. The celestial body catalog 145 can be an FK6 catalog, a HIP2 catalog, a UCAC4 catalog, a GAIA DR1 catalog, or any other catalog. The celestial body catalog 145 can store, or include data that indicates or can be used to determine, the position of celestial bodies at points in time. For example, the data processing system 105 (e.g., the star tracker 150, the dispersion or refraction system 160, or the co-sighting system 175) can lookup celestial bodies in the celestial body catalog 145 with a current time or a future time. The data processing system 105 can include a clock that indicates a second, minute, hour, day, week, month, or year. The data processing system 105 can lookup celestial bodies in the celestial body catalog 145 based on a current time indicated by the clock.

The data processing system 105 can include at least one star tracker 150. The star tracker 150 can receive the second image 125 from the celestial body camera 115. The star tracker 150 can determine an attitude 155 of the system 100 based on the second image 125. The star tracker 150 can compare or match celestial bodies captured in the second image 125 to celestial bodies in the celestial body catalog 145 to determine the attitude 155 of the system 100. The attitude 155 can be or include yaw, pitch, or roll. For example, the second image 125 can include one, two, three, or any number of celestial bodies. For example, the celestial bodies of the second image 125 can form a constellation of celestial bodies. The star tracker 150 can compare constellations of the second image 125 with constellations of the celestial body catalog 145. A match between celestial bodies of the second image 125 and celestial bodies of the celestial body catalog 145 can indicate an orientation of the system 100. Instead of, or in addition to performing star tracking with the second image 125, the star tracker 150 can perform star tracking based on images of a third camera. The star tracker 150 can use the images of the third camera for star tracking, but the dispersion or refraction system 160 or the co-sighting system 175 may not utilize the images of the third camera for navigation.

The data processing system 105 can include at least one dispersion or refraction system 160. The system 160 can determine position of the system 100 from starlight, or from starlight alone. The system 160 can receive the second image 125 from the celestial body camera 115. The system 160 can receive the second image 125 from the celestial body camera 115 oriented towards an atmosphere of the planet. The second image 125 can include light of at least one celestial body refracted or dispersed by the atmosphere of the planet. The system 160 can generate a second position dataset 165 based at least in part on an amount of refraction or dispersion of the light of the celestial body in the second image 125. The system 160 can determine the second position dataset 165 based on the celestial body catalog 145 and the amount of refraction or dispersion of the light of the celestial body in the second image 125. The system 160 can implement a stellar horizon atmospheric refraction (SHAR) technique or a stellar horizon atmospheric dispersion (SHAD) technique to determine the second position dataset 165.

The system 160 can implement the SHAR technique to determine the second position dataset 165 based on an amount of refraction of the star in the atmosphere of the planet. The amount of refraction of the light can form or be linked to different sized cone shapes around the planet. The amount of refraction of the light can change with altitude, and therefore, different altitudes of the system 100 can correspond to different cones. The cones can have different focus levels, e.g., longer or shorter cones, based on the altitude. The system 160 can determine an amount of refraction of the light of the second image 125 based on a constellation of stars in the second image 125. The second images 125 can monitor the horizon of the planet and detect when celestial bodies rise or set over the horizon. However, because the light of the celestial bodies is refracted by the atmosphere of the planet, there may be an error in the position or angle of a rising or setting celestial body relative to other celestial bodies. For example, due to the refraction, a celestial body may rise over the horizon before it should rise when compared to celestial bodies or constellations of the celestial body catalog 145. Furthermore, due to the refraction, a celestial body can set over the horizon before the celestial body should set relative to other celestial bodies or constellations of the celestial body catalog 145.

In this regard, the system 160 can compare celestial bodies captured near the horizon of the planet via the second image 125 to the celestial body catalog 145 to determine an error. The error can be an error in angle measured from the camera 115. For example, the system 160 can identify a constellation of celestial bodies, e.g., one, two, three, or any other number of celestial bodies, captured in the second image 125 based on the celestial body catalog 145. The system 160 can determine an error between the constellation of celestial bodies in the second image and data of the celestial body catalog 145. For example, the error can indicate an angle error or position error of the rising or setting celestial body relative to a position or angle where the celestial body is expected to appear based on the celestial body catalog 145. The system 160 can determine an altitude of the system 100 based on the error value. For example, the system 160 can store links or a mapping between error values and altitudes. The error value or the altitude can correspond with one particular cone, e.g., a cone associated with the refraction of light at a particular altitude. The system 160 monitor the horizon of the planet can identify multiple error values for multiple rising or setting celestial bodies over time to determine multiple errors. The multiple errors can correspond with different altitudes or cones. The system 160 can identify an intersection point or location of multiple cones determined over time. The system 160 can determine a position of the system 100 based on the intersection of the cones. A navigation filter 170 can be applied to the first position dataset 135 and the second position dataset 165 determined based on the error to determine the position and the attitude of the vehicle.

The system 160 can perform a SHAD technique to determine the second position dataset 165. The system 160 can identify a spectrum of light of a celestial body in the second image 125. Various altitudes of the system 100 can correspond to different spectrums of light caused by dispersion of the light of the celestial body in the atmosphere of the planet. Light from a celestial body entering the atmosphere of a planet can change frequency or wavelength based on the altitude at which the light enters the atmosphere. The lower the altitude, the more dispersion may occur. The higher the altitude, the less dispersion may occur. The celestial body catalog 145 can store multiple or a range of spectrums of the light of various celestial bodies corresponding to various altitudes. For example, the celestial body catalog 145 can store mappings or relationships between spectrums of a particular celestial body and altitudes of the system 100. Each altitude can correspond with a different cone. The system 160 can determine a series of cones corresponding with different altitudes of the vehicle as the vehicle travels and the celestial body camera 115 captures the second images 125. The system 160 can determine a point or location where the cones intersect. An intersection of at least two cones can indicate or identify a position of the system 100.

For example, the system 160 can receive an image 125 including a first spectrum of light of a celestial body of the image 125 captured by the celestial body camera 115 at a first point in time. The system 160 can compare the first spectrum of light of the celestial body with the spectrums of light for the celestial body stored in the celestial body catalog 145. For example, the image 125 can indicate a constellation that the celestial body is a part of, and therefore, the system 160 can use the identity of the celestial body to lookup or retrieve spectrums of the celestial body corresponding to different altitudes of the system 100 or different cones. The system 160 can compare the first spectrum to the spectrums of the celestial body. Responsive to identifying a match between the first spectrum and a particular spectrum of the spectrums retrieved from the celestial body catalog 145, the system 160 identify the corresponding altitude or cone associated with the matching spectrum. The system 160 can determine a similarity level or value indicating the similarity between the captured spectrum and the spectrums of the celestial body catalog 145 for the celestial body. The system 160 can select the spectrum from the set of spectrums with a greatest or maximum similarity level, or a similarity level above a threshold. The system 160 can receive another image 125 at a second point in time. For example, after the first image is captured by the celestial body camera 115, the system 160 can capture a second image. The second image can be captured at a second point in time, and because the vehicle can change position (e.g., change altitude) the second spectrum of the second image can be different than the first spectrum of the first image.

With the second image, the system 160 can compare a spectrum of the same celestial body as the first image, or another spectrum of a different celestial body, to spectrums for the celestial body stored in the celestial body catalog 145. The system 160 can determine another match between the received spectrum and a spectrum of the celestial body catalog 145. The system 160 can determine the identity of the celestial body by analyzing or comparing constellations of the image 125 with constellations of the celestial body catalog 145. With the identified celestial body, the system 160 can retrieve spectrums of the celestial body corresponding, linked, or related to different altitudes or cones. The system 160 can compare the second spectrum to the spectrums retrieved from the celestial body catalog 145. A matching or identified spectrum of the catalog 145 can correspond to a different altitude or cone corresponding to the new position of the system 100. The system 160 can compare the first and second cones determined from the different images 125 to determine an intersection. The intersection can relate, or indicate, the position of the system 100, e.g., the second position dataset 165. The second position dataset 165 can be provided to the navigation filter 170. The navigation filter 170 can be applied to the second position dataset 165 determined based on the intersection between the first cone and the second cone.

The second position dataset 165 can include an indication of the position or attitude of the system 100. The second position dataset 165 can indicate the position of the system 100 in an ECI coordinate system. The second position dataset 165 can describe the position of the system 100 with respect to the stars or celestial bodies around a planet (e.g., the Earth) with the planet as a fixed mass. The position can be a two or three-dimensional coordinate. For example, the position can include x, y, and z coordinates. The second position dataset 165 can represent the position of the system 100 with respect to the planet as a fixed mass, where the planet does not rotate. The second position dataset 165 can be in the J2000 ECI frame, the M50 ECI frame, the Geocentric Celestial Reference Frame (GCRF), or any other type of ECI frame of reference.

The data processing system 105 can include at least one co-sighting system 175. The co-sighting system 175 can receive multiple images 125 over time as the system 100 moves through space. Each image 125 can include a star and a planet, moon, or asteroid (e.g., the horizon of a planet, a portion of a planet). For example, in the field of view of each image 125, a planet or moon can be in the foreground while the star can be in the background. In each image 125, both the star and the planet or moon can be visible in the same frame. For example, each image 125 can include the same star or different stars. Each image 125 can include the same planet or different planets. Based on the celestial bodies of each image 125, e.g., stars, planets, moons, etc., the co-sighting system 175 can look up the identity of the celestial bodies in the celestial body catalog 145. Resulting matches between the celestial bodies and celestial bodies int ch celestial body catalog 145 can indicate the orientation of the system 100. The co-sighting system 175 can cause the third position dataset 180 to include the determined orientation.

The co-sighting system 175 can determine, based on an image 125, a line from one star through a planet to the system 100. The co-sighting system 175 can determine, based on the constellations of the celestial body catalog 145, the identity of stars or planets. Because the stars or planets can be many lightyears away from the system 100, if a planet and a star are in the same image, the planet and the star can be assumed to be in a line relative to the system 100, e.g., a line that intersects the star, planet, and system 100. The system 175 can determine that the system 100 is located at some position along the line. With another image 125 of another star and planet (or the same star and a different planet, or the same planet and a different star), the co-sighting system 175 can determine another line that intersects the new star and planet. For example, the data processing system 105 can change position or change the orientation of the celestial body camera 115 to capture another image 125 including a different planet. Again, the system 175 can determine that the system 100 is located at some position along the line. The system 175 can determine that the system 100 is positioned at a point where the two lines intersect. The co-sighting system 175 can determine the third position dataset 180 based on the intersection between the two lines. The co-sighting system 1275 can generate or draw multiple lines for different sets of stars and planets as the images 125 are collected. The co-sighting system 175 can use the lines to triangulate the position of the vehicle 100.

The third position dataset 180 can include an indication of the position or attitude of the system 100. The third position dataset 180 can indicate the position of the system 100 in an ECI coordinate system. The third position dataset 180 can describe the position of the system 100 with respect to the stars or celestial bodies around the Earth with the Earth as a fixed mass. The position can be a two or three-dimensional coordinate. For example, the position can include x, y, and z coordinates. The third position dataset 180 can represent the position of the system 100 with respect to the Earth as a fixed mass, where the Earth does not rotate. The third position dataset 180 can be in the J2000 ECI frame, the M50 ECI frame, the GCRF, or any other type of ECI frame of reference.

The data processing system 105 can include at least one navigation filter 170. The navigation filter 170 can be a filter that combines multiple different data sets, e.g., fuses multiple different types of sensor data together. The navigation filter 170 can use one data set to correct another data set. The navigation filter 170 can be or include an estimation system that uses multiple datasets or a series of values such as a timeseries to estimate values, e.g., to recursively estimate the position or attitude of the system 100. The navigation filter 170 can be a Kalman filter, an extended Kalman filter, and additive extended Kalman filter, a multiplicative extended Kalman filter, or another Kalman filter. The navigation filter 170 can be a smoothing or filtering technique other than a Kalman filter. For example, the navigation filter 170 can be double exponential smoothing.

The navigation filter 170 can determine position 185 and attitude 190. The navigation filter 170 can estimate the position 185 and attitude 190 of the system 100 based on one or a combination of data inputs. For example, the navigation filter 170 can receive the first position dataset 135, the attitude 155, the second position dataset 165, or the third position dataset 180 and generate an estimated position 185 or attitude 190. The position 185 or the attitude 190 can be a corrected or estimated position 185 or attitude 190 determined in one of the first position dataset 135, the attitude 155, the second position dataset 165, or the third position dataset 180. For example, the position 185 and the attitude 190 can have a lower level of error or uncertainty that position or attitude in any one of the filter inputs. The navigation filter 170 can determine the position 185 in either an ECI or an ECEF coordinate frame. The navigation filter 170 can determine a position 185 in an ECI frame and also a position 185 in an ECEF coordinate frame. The position 185 can be cartesian elements (e.g., x, y, and z elements) or Keplerian elements (e.g., eccentricity, semi-major axis, inclination, longitude of the ascending node, argument of periapsis, and true anomaly).

The navigation filter 170 can correct for wobble of the planet under the vehicle. The navigation filter 170 can correct for atmospheric drag of the vehicle. In this regard, the system or vehicle may not rely on any parameter update from a base station on the planet in order to accurately determine position 185. For example, the navigation filter 170 can determine a position 185 that accounts for wobble without receiving or utilizing an EOPP parameter. For example, the navigation filter 170 can determine a position 185 that accounts for atmospheric drag of the vehicle without receiving or utilizing a PE parameter. For example, because the navigation filter 170 combines an attitude determined by the star tracker 150, the system 160, or the co-sighting system 175, the navigation filter 170 can account for wobble of the first position dataset 135 in the ECEF frame. Furthermore, by combining the first position dataset 135 with the second position dataset 165 or the third position dataset 180, atmospheric drag of the vehicle can be accounted for in the second position dataset 165 or the third position dataset 180 in the ECI frame.

The system 100 can further include additional sensors such as a radio detection and ranging (RADAR) system, a light detection and ranging (LIDAR) system, an altimeter, an inertial navigation system (INS), or other navigation systems. The data processing system 105 can receive position, velocity, acceleration, or attitude data from the additional sensors. The received data can be used by the navigation filter 170 to determine the position 185 and the attitude 190.

The data processing system 105 can include at least one control system 195. The control system 195 can be a system that navigates the vehicle based on the position 185 or the attitude 190. Because the position 185 or the attitude 190 determined by the navigation filter 170 can be corrected, and include less error than the first position dataset 135, the second position dataset 165, or the third position dataset 180, the navigation decisions made by the control system 195 can have less error. The control system 195 can determine navigation systems based on the position 185 or the attitude 190, e.g., to maintain an orbit, to maintain an altitude, to reach a destination, to avoid an obstacle. The control system 195 can operate actuators 197 of the system 100 to navigate, position, steer, move, or turn the vehicle. The control system 195 can operate the actuators 197 to change the attitude of the system 100. The control system 195 can operate the actuators 197 to perform at least one orbital maneuver, e.g., to change the orbit of the system 100. The control system 195 can operate the actuators 197 to maintain a particular orbit. The actuators 197 can be rudders, fins, flaps, engines, rockets, ion-drives, reaction wheels, cold gas propulsion systems, magnetorquer systems, electron-cyclotron resonance systems, etc. The actuators 197 can include inverters, motors, drives, valves, solenoids, relays, or other mechanical or electrical component that can actuate to move the vehicle.

The control system 195 can cause at least one display, screen, heads up display, or flight instrument to display the position 185 and the attitude 190. The control system 195 can cause the display to include the position 185 and the attitude 190, instead of, or in addition to, the first position dataset 135, the attitude 155, the second position dataset 165, or the third position dataset 180. The control system 195 can cause the display to simultaneously or individually display ECEF coordinates and ECI coordinates for the vehicle determined by the navigation filter 170. The display can be disposed within a vehicle for a pilot, operator, or passenger to view. The display can be a component of a system located on earth.

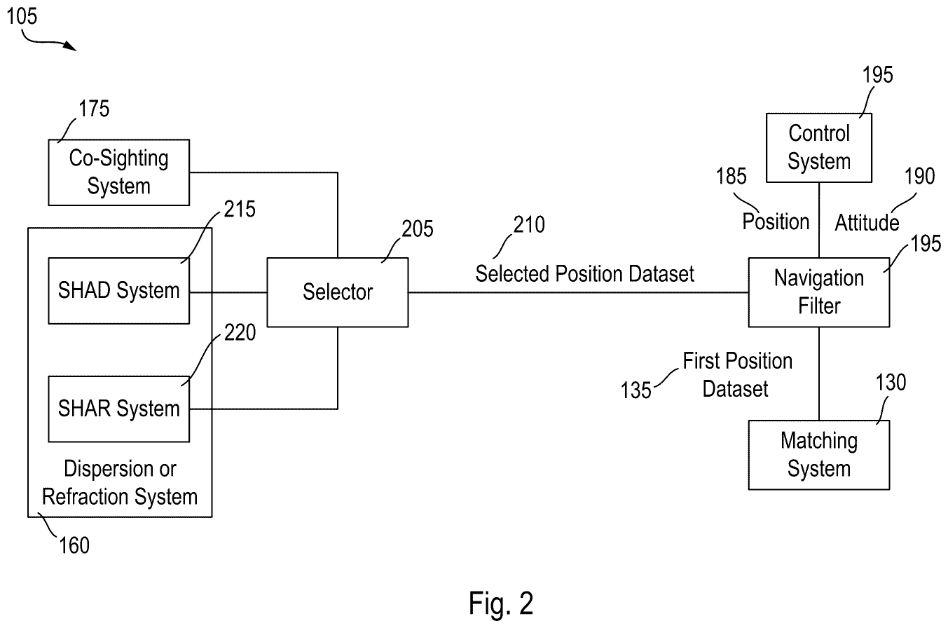

Referring now to FIG. 2, among others, the data processing system 105 selecting between navigating based on light refraction, light dispersion, and co-sighting is shown. The dispersion or refraction system 160 can include at least one SHAD system 215. The SHAD system 215 can implement a SHAD technique to determine the second position dataset 165 based on the second images 125. The dispersion or refraction system 160 can include at least one SHAR system 220. The SHAR system 220 can determine the second position dataset 165 based on a SHAR technique and the second images 125.

The data processing system 105 can include at least one selector 205. The selector 205 can select between the datasets generated, produced, or provided by the co-sighting system 175, the dispersion or refraction system 160, the SHAD system 215, the SHAR system 220. The selector 205 can select between the datasets based on dataset availability. For example, if the co-sighting system 175 or the dispersion or refraction system 160 encounter an error, fault, or stop working, the selector 205 can select the dataset produced by a functioning system. For example, if the selector 205 determines that the co-sighting system 175 stops operating, the selector 205 can select the dispersion or refraction system 160. The selector 205, responsive to making a selection, can cause the co-sighting system 175 to generate the selected position dataset 210 or the dispersion or refraction system 160 to determine the selected position dataset 210.

The selector 205 can select between the co-sighting system 175 and the dispersion or refraction system 160 based on an altitude of the system 100. For example, the selector 205 can receive an altitude from an altitude sensor, such as an altimeter. The selector 205 can operate based on the altitudes indicated by the co-sighting system 175 or the dispersion or refraction system 160. The selected dataset can be output by the selector 205 as the selected position dataset 210. The selector 205 can provide the selected position dataset 210 to the navigation filter 170. The navigation filter 170 can determine the position 185 and the attitude 190 based on the selected position dataset 210 and the first position dataset 135. The selector 205 can select the dispersion or refraction system 160 if the altitude is less than a threshold. The selector 205 can select the co-sighting system 175 when the altitude reaches or exceeds the threshold. For example, the threshold can be an orbit between NEO orbit and GEO orbit. For example, if the system 100 reaches a GEO orbit, the selector 205 can switch from the dispersion or refraction system 160 to the co-sighting system 175. The threshold can be based on a configuration of the celestial body camera 115. For example, a size of a telescope, a number of pixels of the telescope, etc. can be used to determine the threshold. The threshold can cause a switch between the system 160 and the co-sighting system 175 because to continue using the system 160, the telescope of the celestial body camera 115 may need to be large, and it may not be economical to use a large sized telescope in a GEO orbit.

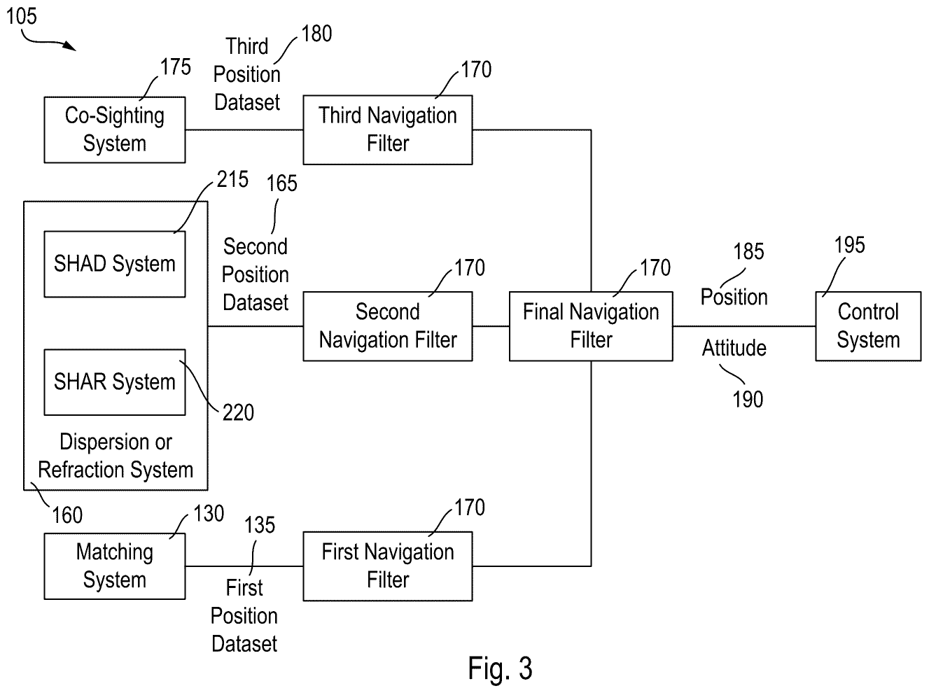

Referring now to FIG. 3, among others, the data processing system 105 applying a first navigation filter 170 to a first position dataset determined from landmark data, a filter to a second position dataset determined from refraction or dispersion, and a filter to a third position dataset determined from co-sighting. The data processing system 105 can apply a different navigation filter 170 to each dataset. The filtered position dataset output by each navigation filter 170 can be combined by a final navigation filter 170, which determines the position 185 and the attitude 190 based on each filtered dataset.

For example, the data processing system 105 can apply the first navigation filter 170 to the first position dataset 135 determined by the matching system 130 and provide the filtered first position dataset 135 to the final navigation filter 170. For example, the data processing system 105 can apply the second navigation filter 170 to the second position dataset 165 determined by the system 160 and provide the filtered second position dataset 165 to the final navigation filter 170. For example, the data processing system 105 can apply the third navigation filter 170 to the third position dataset 180 determined by the matching system 130 and provide the filtered third position dataset 180 to the final navigation filter 170. The final navigation filter 170 can be applied to the filtered first position dataset 135, the filtered second position dataset 165, and the filtered third position dataset 180 to determine the position 185 and the attitude 190.

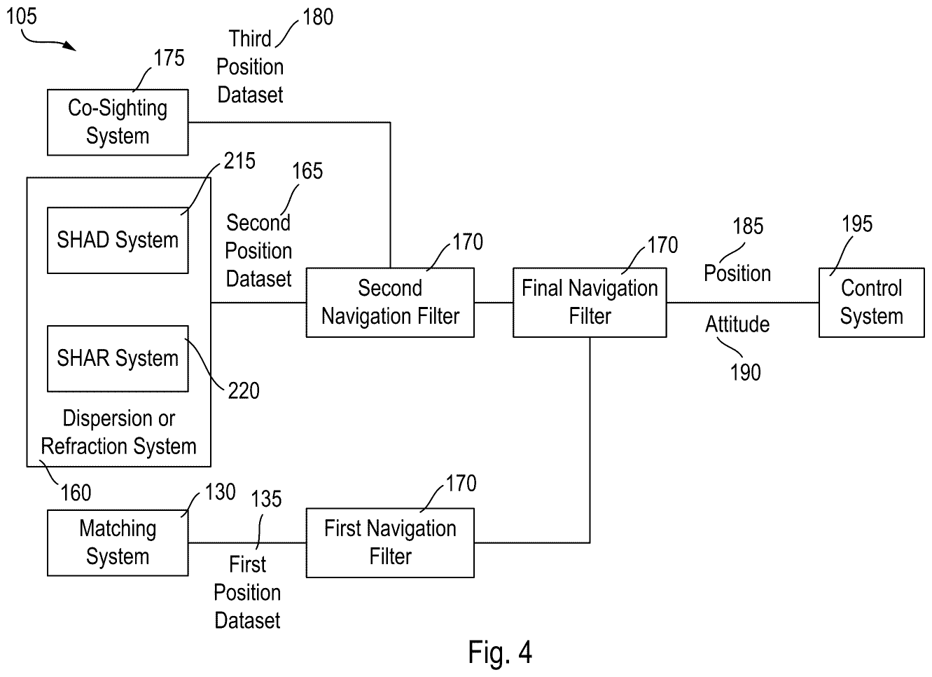

Referring now to FIG. 4, among others, the data processing system 105 combining position datasets determined with a co-sighting technique and a SHAD or SHAR technique to generate a filtered dataset, and a second filter that combines the filtered dataset with a position dataset determined from landmark data is shown. The data processing system 105 can apply a first navigation filter 170 to the first position dataset 135. The first navigation filter 170 can correct or reduce errors in the values of the first position dataset 135. Furthermore, the data processing system can apply a second navigation filter 170 to the second position dataset 165 and the third position dataset 180. The second navigation filter 170 can correct the second position dataset 165 or the third position dataset 180. The filtered dataset output by the second navigation filter 170 can have reduced or corrected errors. The position dataset output by the second navigation filter 170 can be based on a combination of the second position dataset 165 and the third position dataset 180. The filtered position datasets output by the first navigation filter 170 and the second navigation filter 170 can be input to the navigation filter 170, which the navigation filter 170 can use to output the position 185 and the attitude 190.

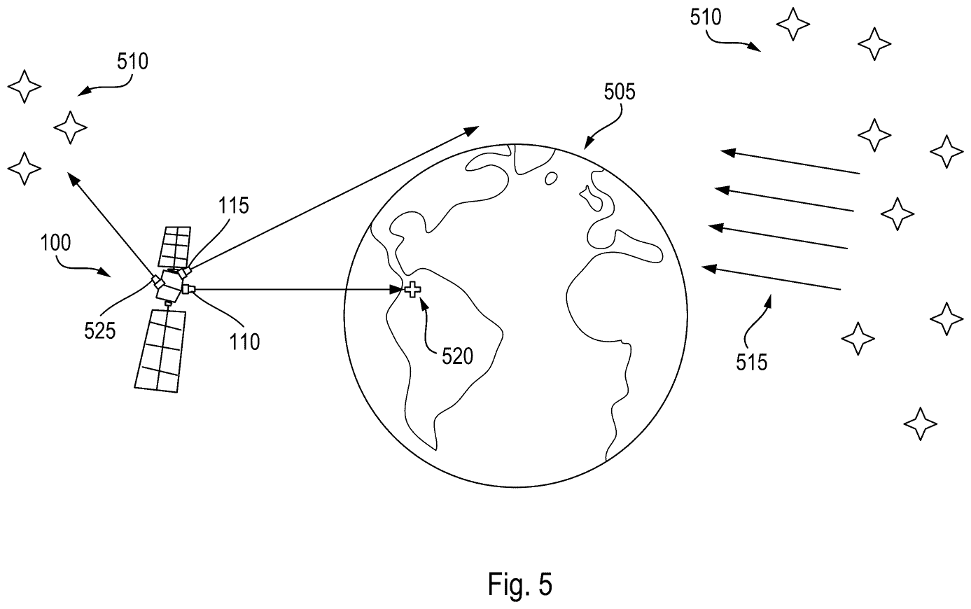

Referring now to FIG. 5, among others, the vehicle 100 above a planet 505 including the landmark camera 110 and the celestial body camera 115 is shown. The vehicle 100 can include one, two, three, four, or any number of cameras. The cameras can be coupled with the vehicle 100. The vehicle 100 can include one or multiple imaging devices, e.g., complementary metal-oxide-semiconductor (CMOS) devices, charge coupled devices (CCDs), etc. The vehicle 100 can include multiple telescopes or apparatus and prisms, mirrors, or waveguides that direct might from multiple telescopes to a single imaging device. For example, a horizon camera, a downward camera, and a star camera can all provide light to a single imaging device to produce digital images.

The vehicle 100 can include a first camera 110 that is coupled with the vehicle 100 and oriented towards the planet 505 below the vehicle 100. The landmark camera 110 can be positioned on the vehicle 100 and oriented towards a surface of the planet 505. The landmark camera 110 can look downwards and capture images 120 of the surface of the planet 505. The images 120 include images, pictures, or data representing landmarks 520 on the surface of the planet 505. The landmark 520 can be or include a road, a mountain, a forest, a river, a building, a city, an airfield, a road intersection.

The vehicle 100 can include at least one celestial body camera 115. The celestial body camera 115 can capture images of celestial bodies 510. The celestial bodies 510 can include planets, moons, stars, galaxies, asteroids, vehicles, nebulas, quasars, or comets. The celestial body camera 115 can be coupled with the vehicle 100. The celestial body camera 115 can be oriented towards a horizon of the planet 505. Light 515 of celestial bodies 510 can be columnated. The camera 115 can receive the light 515 and generate an image of at least one celestial body 510.

The vehicle 100 can include at least one third camera 525. The third camera 525 can capture third images at a rate and provide the third images to the data processing system 105 as the third images are captured. The third camera 525 can capture images that the star tracker 150 uses to generate the attitude 155. The third camera 525 can capture images that the co-sighting system 175 utilizes to generate the third position dataset 180. The third camera 525 can be coupled with the vehicle 100. The third camera 525 can be oriented away from the planet 505, or can capture images of celestial bodies 510. The third camera 525 (and also the landmark cameras 110 or the celestial body camera 115) can move from position to position. For example, the data processing system can operate the third camera 525 to point at a first planet or moon, and then point at a second point or moon to capture images to be used by the co-sighting system 175.

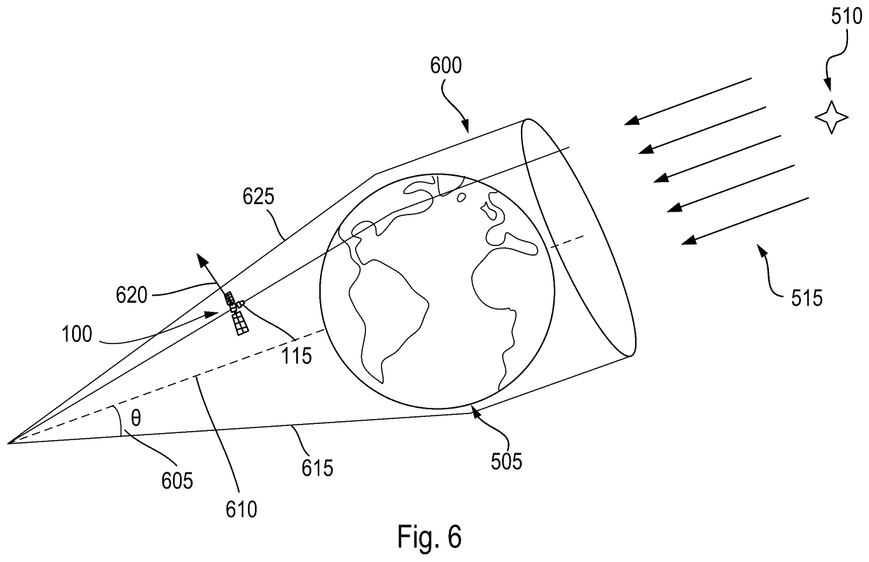

Referring now to FIG. 6, among others, an example of a cone 600 for an altitude of the vehicle 100 that can be determined based on refraction or dispersion is shown. In FIG. 6, columnated light 515 from a celestial body 510 is received by the celestial body camera 115. The celestial body 510 can be behind the planet 505. For example, the planet 505 can be between the vehicle 100 and the star 510. For example, the planet 505 can be on a straight line drawn behind the vehicle 100 and the star 510. Even though the light 515 is columnated, the light 515 can be diffracted or dispersed by the atmosphere of the planet. The light 515 can be diffracted at differing refraction angles 605 based on the altitude that the light enters the atmosphere at. The camera 110 can observe the light on ray 625. The system 160 can compute or determine the refraction angle. The refraction angle 605 can correspond to a different cones 600. The cone 600 can be defined as having a cone axis 610. The cone axis 610 can pass through the center of the planet 505. The refraction angle 605 can be measured or calculated to be the angle between the cone axis 610 and the light leaving the atmosphere at 615. FIG. 6 further indicates an update direction 620, which can be a direction perpendicular to the surface of the cone 600.

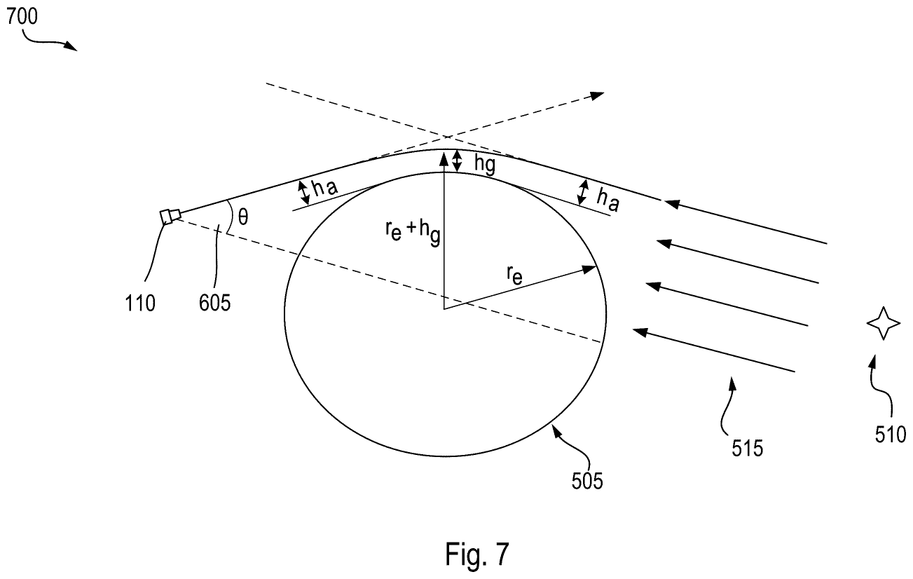

Referring now to FIG. 7, among others, an example schematic diagram 700 of measurements used to determine the position of the vehicle 100 based on light refraction. In FIG. 7, the columnated light 515 of a celestial body 510 is shown to refract in the atmosphere of the planet 505. The light 515 enters the atmosphere at an altitude of ha, and refracts in the atmosphere of the planet 505. The light 515 can curve around the planet 505 at an altitude hg. The planet can have a radius re, and a distance from the center of the planet 505 to the point where the light 515 curves around the planet 505 can be re+hg.

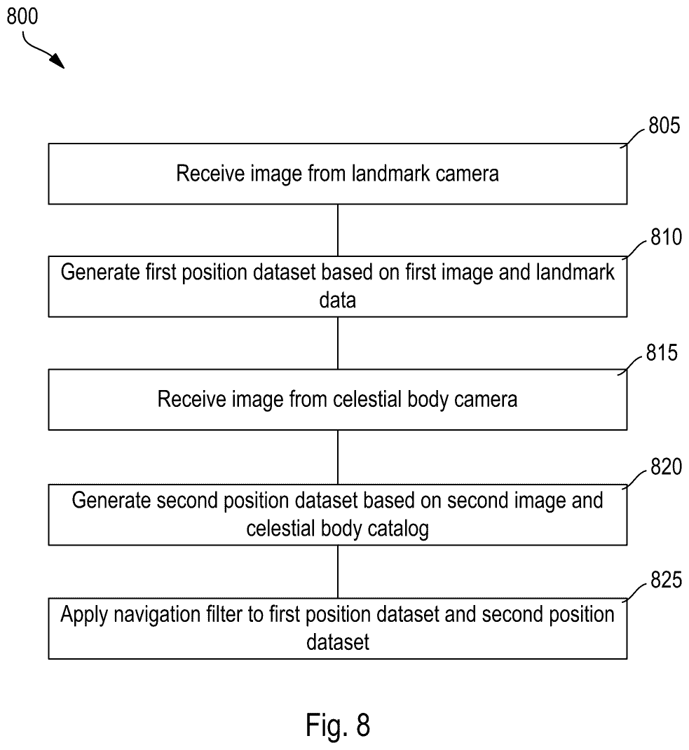

Referring now to FIG. 8, among others, an example method 800 of determining a position and attitude of the vehicle based on landmark data and light refraction or dispersion is shown. At least a portion of the method 800 can be performed by the data processing system 105. At least a portion of the method 800 can be performed by computer or processing system or circuit on board to a vehicle. At least a portion of the method 800 can be performed remote from the vehicle. A piece of software or hardware can perform at least a portion of the method 800. The method 800 can include an ACT 805 of receiving an image from a downward camera. The method 800 can include an ACT 810 of generating a first position dataset based on a first image and landmark data. The method 800 can include an ACT 815 of receiving an image from a celestial body camera. The method 800 can include an ACT 820 of generating a second position dataset based on a second image and a celestial body catalog. The method 800 can include an ACT 825 of applying a navigation filter to a first position dataset and a second position dataset.

At ACT 805, the method 800 can include receiving, by the data processing system 105, an image 120 from a landmark camera 110. The landmark camera 110 can be coupled with an underside of the vehicle 100 that faces a surface of the planet 505 under the vehicle 100. The vehicle 100 can orient itself such that the landmark camera 110 is pointed towards the surface of the planet 505. The image 120 can include images, pictures, or data representing landmarks 520 of the planet 505, such as a road, a mountain, a forest, a river, a building, a city, an airfield, a road intersection.

At ACT 810, the method 800 can include generating, by the data processing system 105, a first position dataset 135 based on the first image 120 and landmark data 140. The data processing system 105 can include a matching system 130 that matches the first image 120 to the landmark data 140. The matching system 130 can perform a search of the landmark data 140 to determine an identity or location of the landmark 520. Based on the identity and location of the landmark 520 determined by the matching system 130, the matching system 130 can determine a position and orientation of the vehicle 100. For example, the orientation of the landmark 520 in the image 120 can indicate the attitude of the vehicle 100 based on a known orientation of the landmark camera 110 on the vehicle 100. Furthermore, based on a zoom level of the landmark camera 110 and a resulting size of the landmark 520 in the first image 120, the matching system 130 can determine an altitude of the vehicle 100. The identity and location of the landmark 520 indicated by the landmark data 140 can indicate the lateral position of the vehicle 100.

At ACT 815, the method 800 can include receiving, by the data processing system 105, an image 125 from a celestial body camera 115. The celestial body camera 115 can be oriented at a horizon of the planet 505. The celestial body camera 115 can capture an image 125 that includes celestial bodies 510 and at least a portion of the horizon of the planet 505. The method 800 can include receiving multiple images 125 from the camera 115 over time. For example, the data processing system 105 can include a first image 120 at a first point in time, a second image at a second point in time, a third image at a third point in time, etc. As the data processing system 105 receives the images 125, and as the celestial body camera 115 captures images 125, the vehicle 100 can change lateral position, orientation, or altitude.

At ACT 820, the method 800 can include generating, by the data processing system 105, a second position dataset 165 based on the second image 125 and a celestial body catalog 145. The data processing system 105 can apply a SHAD technique or a SHAR technique to determine the second position dataset 165. For example, the data processing system 105 can apply a SHAR technique to determine an amount of refraction of light of a celestial body in the atmosphere of the planet. The amount of refraction seen by the camera 115 can be based on an altitude of the vehicle 100. The data processing system 105 can detect a constellation of celestial bodies 510 in the images 125 based on the celestial body catalog 145. The data processing system 105 can determine, based on other stars in the constellation, that a star in the constellation sets or rises before anticipated based on the data of the celestial body catalog 145. The setting or rising of the star relative to the other celestial bodies in the constellation can indicate an amount of refraction, and therefore an altitude of the vehicle 100. The data processing system 105 can determine an altitude of the vehicle 100 from the amount of the refraction, e.g., using a mapping or relationship. The altitude of the vehicle 100 can correspond to a cone shape around the planet 505. As the vehicle 100 navigates, the data processing system 105 can capture multiple refraction angles, altitudes, and cones. The data processing system 105 can identify an intersection point in two or more cones to determine the position of the vehicle 100. For example, the point at which two consecutively determined cones intersection can be the position of the vehicle 100.

The data processing system 105 can apply the SHAD technique to determine the second position dataset 165. The SHAD technique can indicate or determine a dispersion of light 515 of a celestial body 510. The data processing system 105 can compare a spectrum of light captured by the image 125 to spectrums of light of the celestial body 510 corresponding to different amounts of dispersion, and therefore different altitudes of the vehicle 100. The data processing system 105 can detect a match between the spectrum of light captured by the image 125 and a particular spectrum of light for the celestial body 510 stored by the celestial body catalog 145. The particular spectrum of light identified by the data processing system 105 can correspond to or indicate an altitude of the vehicle 100. The particular spectrum of light can indicate a cone of light. As the vehicle 100 navigates, the data processing system 105 can capture multiple light spectrums, altitudes, and cones. The data processing system 105 can identify an intersection point in two or more cones to determine the position of the vehicle 100. For example, the point at which two consecutively determined cones intersect can be the position of the vehicle 100.

At ACT 825, the method 800 can include applying, by the data processing system, a navigation filter 170 to a first position dataset 135 and a second position dataset 165. Furthermore, the data processing system 105 can apply the navigation filter 170 to the first position dataset 135, the second position dataset 165, the third position dataset 180, or the attitude 155. The navigation filter 170 can generate a position 185 and an attitude 190 based on the first position dataset 135, the second position dataset 165, the third position dataset 180, or the attitude 155. The resulting position 185 and attitude 190 may not require a correction for wobble of the earth or atmospheric drag of the vehicle 100. The navigation filter 170 can correct for error, inaccuracy, or noise in the first position dataset 135, the second position dataset 165, or the third position dataset 180.

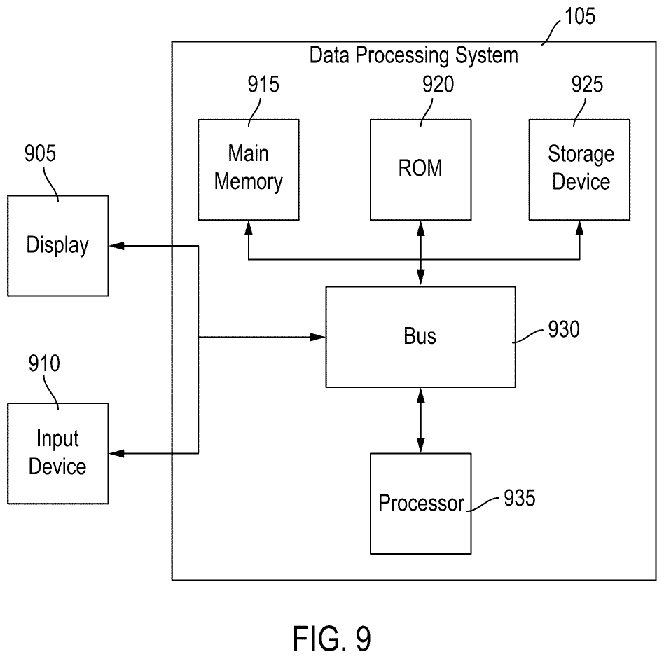

Referring now to FIG. 9, among others, an example computing architecture of the data processing system 105 that can implement the systems and methods discussed herein is shown. The data processing system 105 includes at least one bus 930 or other communication component for communicating information and at least one processor 935 or processing circuit coupled to the bus 930 for processing information. The data processing system 105 can also include one or more processors 935 or processing circuits coupled to the bus for processing information. The data processing system 105 can include at least one main memory 915, such as a random access memory (RAM) or other dynamic storage device, coupled to the bus 930 for storing information, and instructions to be executed by the processor 935. The main memory 915 can be used for storing information during execution of instructions by the processor 935. The data processing system 105 can further include at least one read only memory (ROM) 920 or other static storage device coupled to the bus 930 for storing static information and instructions for the processor 935. A storage device 925, such as a solid state device, magnetic disk or optical disk, can be coupled to the bus 930 to persistently store information and instructions.

The data processing system 105 may be coupled via the bus 930 to a display 905, such as a liquid crystal display, or active matrix display, for displaying information to a user such as a pilot, operator, navigator, sailor, or user. An input device 910, such as a keyboard or voice interface may be coupled to the bus 930 for communicating information and commands to the processor 935. The input device 910 can include a touch screen display 905. The input device 910 can also include a cursor control, such as a mouse, a trackball, or cursor direction keys, for communicating direction information and command selections to the processor 935 and for controlling cursor movement on the display 905.

The processes, systems and methods described herein can be implemented by the data processing system 105 in response to the processor 935 executing an arrangement of instructions contained in main memory 915. Such instructions can be read into main memory 915 from another computer-readable medium, such as the storage device 925. Execution of the arrangement of instructions contained in main memory 915 causes the data processing system 105 to perform the illustrative processes described herein. One or more processors in a multi-processing arrangement may also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, Python, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method ACTS or system elements, those ACTS and those elements may be combined in other ways to accomplish the same objectives. ACTS, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
a data processing system comprising one or more processors, coupled with memory, to:
receive a first image of a surface of a planet from a first camera of a vehicle;
generate a first position dataset based on the first image and data representing landmarks of the surface of the planet;
receive, by a second camera of the vehicle oriented towards an atmosphere of the planet, a second image that includes light of a celestial body refracted or dispersed by the atmosphere of the planet;
generate, via a celestial body catalog, a second position dataset based at least in part on an amount of refraction or dispersion of the light of the celestial body in the second image; and
determine, based on a filter applied to the first position dataset and the second position dataset, a position and attitude of the vehicle.

2. The system of claim 1, comprising:
the data processing system to:
match two or more celestial bodies of the second image or a third image of a third camera with celestial bodies of the celestial body catalog to determine the attitude of the vehicle; and
correct, based on the filter applied to the first position dataset, the second position dataset, and the attitude determined from the two or more celestial bodies, the position and the attitude of the vehicle.

3. The system of claim 1, comprising:
the data processing system to:
determine, based on the filter applied to the first position dataset and the second position dataset, the position of the vehicle in an earth centered inertial coordinate system and an earth centered earth fixed coordinate system.

4. The system of claim 1, comprising;
the data processing system to:
correct, based on the filter applied to the first position dataset and the second position dataset, for a wobble of the planet and for an atmospheric drag of the vehicle without receiving an update parameter from a base station.

5. The system of claim 1, comprising:
the data processing system to:
receive a third image captured at a first point in time and a fourth image captured at a second point in time from the second camera or a third camera, the third image including a first star and a first planet, the fourth image including a second star and a second planet;
determine a third position dataset based on the third image and the fourth image; and
determine, based on the filter applied to the first position dataset, the second position dataset, and the third position dataset, the position and the attitude of the vehicle.

6. The system of claim 1, comprising:
the data processing system to:
receive a third image captured at a first point in time and a fourth image captured at a second point in time from the second camera or a third camera, the third image including a first star and a first planet, the fourth image including a second star and a second planet;
determine a third position dataset based on the third image and the fourth image;
apply a first filter to the first position dataset;
apply a second filter to the second position dataset;
apply a third filter to the third position dataset; and
apply the filter to the first position dataset filtered by the first filter, the second position dataset filtered by the second filter, and the third position dataset filtered by the third filter to determine the position and the attitude of the vehicle.

7. The system of claim 1, comprising:
the data processing system to:
receive a third image captured at a first point in time and a fourth image captured at a second point in time from the second camera or a third camera, the third image including a first star and a first planet, the fourth image including a second star and a second planet;
determine a third position dataset based on the third image and the fourth image;
correct, based on a first filter applied to the second position dataset and the third position dataset, the second position dataset; and
apply the filter to the corrected first position dataset and the corrected second position dataset.

8. The system of claim 1, comprising:
the data processing system to:
receive an altitude of the vehicle;
select between a co-sighting technique or at least one of a stellar horizon atmospheric dispersion or stellar horizon atmospheric refraction technique based on the altitude;
generate the second position dataset based on the stellar horizon atmospheric dispersion or the stellar horizon atmospheric refraction technique and apply the filter to the first position dataset and the second position dataset responsive to a selection of the stellar horizon atmospheric dispersion or the stellar horizon atmospheric refraction technique; and
generate a third position dataset based on the co-sighting technique and apply the filter to the first position dataset and the third position dataset responsive to a selection of the co-sighting technique.

9. The system of claim 1, comprising:
the data processing system to:
identify a constellation of celestial bodies in the second image based on the celestial body catalog, the constellation of celestial bodies including the celestial body and a second celestial body;
determine an error between the constellation of celestial bodies in the second image and data the celestial body catalog;
determine the second position dataset based at least in part on the error; and
apply the filter to the first position dataset and the second position dataset determined based on the error to determine the position and the attitude of the vehicle.

10. The system of claim 1, comprising:
the data processing system to:
compare a first spectrum of the light of the celestial body of the second image captured by the second camera at a first point in time to a plurality of spectrums of the light of the celestial body at a plurality of altitudes;
determine a first cone associated with the position of the vehicle based on the comparison of the first spectrum of the light to the plurality of spectrums;
compare a second spectrum of the light of the celestial body of the second image captured by the second camera at a second point in time to the plurality of spectrums of the light of the celestial body at the plurality of altitudes;
determine a second cone associated with a second position of the vehicle based on the comparison of the second spectrum of the light to the plurality of spectrums;
determine the first position dataset based on an intersection of the first cone and the second cone; and
determine, based on the filter applied to the first position dataset and the second position dataset determined based on the intersection of the first cone and the second cone, the position and the attitude of the vehicle.

11. The system of claim 1, comprising:
the first camera, the first camera coupled with the vehicle and oriented towards the planet below the vehicle; and
the second camera, the second camera coupled with the vehicle and oriented towards a horizon of the planet.

12. A method, comprising:
receiving, by processing circuitry, a first image of a surface of a planet from a first camera of a vehicle;
generating, by the processing circuitry, a first position dataset based on the first image and data representing landmarks of the surface of the planet;
receiving, by the processing circuitry from a second camera of the vehicle oriented towards an atmosphere of the planet, a second image that includes light of a celestial body refracted or dispersed by the atmosphere of the planet;
generating, by the processing circuitry via a celestial body catalog, a second position dataset based at least in part on an amount of refraction or dispersion of the light of the celestial body in the second image; and
determining, by the processing circuitry based on a filter applied to the first position dataset and the second position dataset, a position and attitude of the vehicle.

13. The method of claim 12, comprising:
matching, by the processing circuitry, two or more celestial bodies of the second image or a third image of a third camera with celestial bodies of the celestial body catalog to determine the attitude of the vehicle; and
correcting, by the processing circuitry, based on the filter applied to the first position dataset, the second position dataset, and the attitude determined from the two or more celestial bodies, the position and the attitude of the vehicle.

14. The method of claim 12, comprising:
determining, by the processing circuitry, based on the filter applied to the first position dataset and the second position dataset, the position of the vehicle in an earth centered inertial coordinate system and an earth centered earth fixed coordinate system.

15. The method of claim 12, comprising:
receiving, by the processing circuitry, a third image captured at a first point in time and a fourth image captured at a second point in time from the second camera or a third camera, the third image including a first star and a first planet, the fourth image including a second star and a second planet;
determining, by the processing circuitry, a third position dataset based on the third image and the fourth image; and
determining, by the processing circuitry based on the filter applied to the first position dataset, the second position dataset, and the third position dataset, the position and the attitude of the vehicle.

16. The method of claim 12, comprising:
receiving, by the processing circuitry, an altitude of the vehicle;
selecting, by the processing circuitry, between a co-sighting technique or at least one of a stellar horizon atmospheric dispersion or stellar horizon atmospheric refraction technique based on the altitude;
generating, by the processing circuitry, the second position dataset based on the stellar horizon atmospheric dispersion or the stellar horizon atmospheric refraction technique and apply the filter to the first position dataset and the second position dataset responsive to a selection of the stellar horizon atmospheric dispersion or the stellar horizon atmospheric refraction technique; and
generating, by the processing circuitry, a third position dataset based on the co-sighting technique and apply the filter to the first position dataset and the third position dataset responsive to a selection of the co-sighting technique.

17. The method of claim 12, comprising:
identifying, by the processing circuitry, a constellation of celestial bodies in the second image based on the celestial body catalog, the constellation of celestial bodies including the celestial body and a second celestial body;
determining, by the processing circuitry, an error between the constellation of celestial bodies in the second image and data the celestial body catalog;
determining, by the processing circuitry, the second position dataset based at least in part on the error; and
applying, by the processing circuitry, the filter to the first position dataset and the second position dataset determined based on the error to determine the position and the attitude of the vehicle.

18. The method of claim 12, comprising:
comparing, by the processing circuitry, a first spectrum of the light of the celestial body of the second image captured by the second camera at a first point in time to a plurality of spectrums of the light of the celestial body at a plurality of altitudes;
determining, by the processing circuitry, a first cone associated with the position of the vehicle based on the comparison of the first spectrum of the light to the plurality of spectrums;
comparing, by the processing circuitry, a second spectrum of the light of the celestial body of the second image captured by the second camera at a second point in time to the plurality of spectrums of the light of the celestial body at the plurality of altitudes;
determining, by the processing circuitry, a second cone associated with a second position of the vehicle based on the comparison of the second spectrum of the light to the plurality of spectrums;
determining, by the processing circuitry, the first position dataset based on an intersection of the first cone and the second cone; and
determining, by the processing circuitry based on the filter applied to the first position dataset and the second position dataset determined based on the intersection of the first cone and the second cone, the position and the attitude of the vehicle.

19. One or more computer-readable media storing instructions thereon, that, when executed by one or more processors, cause the one or more processors to:
receive a first image of a surface of a planet from a first camera of a vehicle;
generate a first position dataset based on the first image and data representing landmarks of the surface of the planet;
receive, by a second camera of the vehicle oriented towards an atmosphere of the planet, a second image that includes light of a celestial body refracted or dispersed by the atmosphere of the planet;
generate, via a celestial body catalog, a second position dataset based at least in part on an amount of refraction or dispersion of the light of the celestial body in the second image; and
determine, based on a filter applied to the first position dataset and the second position dataset, a position and attitude of the vehicle.

20. The one or more computer-readable media of claim 19, wherein the instructions cause the one or more processors to:
match two or more celestial bodies of the second image or a third image of a third camera with celestial bodies of the celestial body catalog to determine the attitude of the vehicle; and
correct, based on the filter applied to the first position dataset, the second position dataset, and the attitude determined from the two or more celestial bodies, the position and the attitude of the vehicle.
